(19) United States
(12) Patent Application Publication
(10) Pub. No.: US 2005/0220996 A1
(43) Pub. Date: Oct. 6, 2005

(54) Process for coating a pharmaceutical particle

(76) Inventors: Larry L. Berger, Chadds Ford, PA (US); Nutan Gangrade, Hockessin, DE (US); Qian Qiu Zhao, Hockessin, DE (US); Sean Mark Dalziel, Wilmington, DE (US); George A. Schurr, Newark, DE (US); Thomas Friedmann, Hockessin, DE (US); Torence John Trout Jr., West Chester, PA (US)

Correspondence Address: Barbara C Siegell;E I du Pont de Nemours & Company, Legal Patents, Wilmington, DE, 19898, US

(21) Appl. No.: 10/521,369

(22) PCT Filed: Aug. 14, 2003
(86) PCT No.: PCT/US03/25883

§ 371 Date: Jan. 12, 2005

Related U.S. Application Data
(60) Provisional application No. 60/403,487, filed on Aug. 14, 2002.

(51) Int. Cl. B05D 7/00

(52) U.S. Cl. 427/213

(57) ABSTRACT

A process of coating to create pharmaceutical particles is disclosed. The coating can enhance the pharmaceutical particle by providing a controlled release barrier, moisture barrier, surface modifying agent, wetting agent, flowability or fluidizing agent, hydrophobicity or hydrophilicity agent, flavor masking agent, odor masking agent, release control agent, or coloring agent; or an inert particle can be coated with a pharmaceutically active liquid. Also disclosed are coated pharmaceutical particles made by one of the processes of the invention.

This application claims the benefit of U.S. Provisional Application No. 60/403487, filed Aug. 14, 2002.

### FIELD OF THE INVENTION

A process for coating a pharmaceutical particle with a liquid coating material is disclosed. The coating is able to provide useful characteristics to the particles, for example, by providing a moisture barrier, improving stability, enhancing wettability, enhancing dispersion, flowability and fluidability, increasing or delaying release of pharmaceutically-active ingredients, masking off-flavors, masking odors, and coloring the particle.

### TECHNICAL BACKGROUND

A considerable number of prescription and over-the-counter pharmaceuticals are currently sold with surface coatings to enhance the value of the product. Coating technology in this industry is known, for example, to impart such important characteristics as taste masking, stability enhancement, and controlled release of the active; wherein the rate of release can be increased, delayed, or sustained over time for prolonged delivery.

For example, the rate of delivery of a pharmaceutical to a target organism or reaction site is often critical to obtaining the desired result. Too much of a medicine ingested or injected all at once in order to have a maintenance concentration can result in wasted material or cause toxic side effects. The coating of pharmaceuticals helps reduce these problems, ensures stability, and prolongs the shelf-life of reactive ingredients. Furthermore, coating is an effective way of masking the taste or odor of a particular drug, making products more palatable, which operates to increase patient compliance in taking medications, especially in populations of pediatric or geriatric patents by enabling chewable or suspension formulations of oral drugs.

In conventional dry coating systems substrates for coating are limited to relatively large particles (tablets, pellets and granules, which are significantly greater than 200 μm). Examples of such processes include Wurster type or other fluidized bed technologies and pan coating. Since these processes can not efficiently operate with discrete drug crystals (generally less than 200 μm and most commonly from 1-80 μm), there is a need for new technologies that can deliver the functionality of pharmaceutical tablet and granule coatings, but at the primary drug particle scale. Conventional tablet, pellet and granule coating processes suffer quality and processing problems in some circumstances, such as the coated product being not uniformly coated (or cracking of the coating), resulting in pharmaceutical particles demonstrating undesirable release profiles, poor protection for enteric products, in consistencies in bioavailability, off-flavors, pungent odors, ingredient interactions, and poorer product stability. Conventional wet coating processes are further limited wherein the material to be coated needs to be poorly soluble in a solvent wherein it is first immersed or dispersed to achieve coating. This creates a need for solvent handling, solids/liquid separation and drying operations, recovery inefficiencies, generation of waste of the active ingredient as well as solvents and coating agents. For a review of the conventional coating techniques, see Gibbs et al. (1999) Int. J. Food Sci. Nutr. 50, 213-224. Also, see Chapter 8, “Processing and Equipment Considerations for Aqueous Coatings,” A.M. Mehta, in “Aqueous Pharmaceutical Coatings for Pharmaceutical Dosage Forms,” edited by James W. McGinty (2ed) 1997, 287-326.

U.S. Pat. Nos. 3,241,520 and 3,253,944 disclose a particle coating method wherein relatively large pellets, granules and particles are suspended in a stream of air while coating material in a liquid form is mixed with the particles.

An apparatus and process for coating small solid particles materials is described in WO 97/07879 published Mar. 6, 1997, and assigned to E. I. du Pont de Nemours and Company. This process involves metering a liquid composition comprising a coating material, where the liquid composition is either a solution, slurry, or melt, into a flow restrictor and injecting a gas stream through the flow restrictor concurrently with the metering of the liquid composition to create a zone of turbulence at the outlet of the flow restrictor, thereby atomizing the liquid composition. The gas stream is optionally heated prior to injecting it through the flow restrictor. A solid particle is added to the zone of turbulence concurrently with the metering of the liquid composition and the injection of the heated gas to mix the solid particle with the atomized liquid composition. The mixing of the atomized coating composition with the particles at the zone of turbulence instantly coats the solid particle with the coating material, wherein the coated particle then emerges in a dry state from the apparatus.

WO 97/07676 to E.I. du Pont de Nemours and Company discloses the apparatus of WO 97/07879, along with the use of the apparatus in a process for coating crop protection solid particles. Coatings are water-insoluble, and extent of coating is represented by weight percent.

Applicants' assignee's copending application having Application number 10/174687, filed Jun. 19, 2002 discloses a process for dry coating a food particle having its largest diameter in the range from 0.5 mm to 20.0 mm with a liquid coating material using the process disclosed in WO 97/07879. The final coated food particle has a moisture level that is substantially the same as the moisture level of the uncoated food particle. Also disclosed is a process for encapsulating a frozen liquid particle having a size in the range from 5 micrometers to 5 millimeters with a liquid coating material.

Applicants' assignees' copending utility patent applications having Attorney Docket numbers CL2101, CL2148, CL2149, CL9150, and PTI sp1255 disclose subject matter related to the present application, and are specifically incorporated herein by reference.

There is a need in the pharmaceutical industry for an economically efficient process for coating pharmaceutical particles in such a manner that individual pharmaceutical particles have independent time-release characteristics, surface aspects enhancing fluidity, flowability and wettability, have extended shelf-life and improved stability, are protected from moisture, and have pleasing taste and odor characteristics. The present invention addresses these needs.

### SUMMARY OF THE INVENTION

The present invention concerns a process for coating a pharmaceutical particle with a liquid, the process comprising the steps of:
(a) metering a coating liquid into a flow restrictor;
(b) injecting a gas stream through the flow restrictor concurrently with step (a) to (i) atomize the coating liquid and (ii ) create turbulent flow of the gas stream, wherein the gas stream is optionally heated; and
(c) adding a pharmaceutical particle to the turbulent flaw region concurrently with steps (a) and (b) wherein the pharmaceutical particle mixes with the atomized coating liquid in the region of turbulent flow, to provide a coated pharmaceutical particle.

In a related second embodiment, the present invention also concerns a process for coating a pharmaceutical particle with a liquid, the process comprising the steps of:
(a) metering a coating liquid containing pharmaceutical particles into a flow restrictor, and
(b) injecting a gas stream through the flow restrictor concurrently with step (a) to (i) atomize the coating liquid and (ii) create turbulent flow of the gas stream and the atomized coating liquid, wherein the gas stream is optionally heated;
   wherein the pharmaceutical particle mixes with the atomized coating liquid in the region of turbulent flow to provide a coated pharmaceutical particle.

In additional embodiments, these processes of the invention further comprise repeating the coating process in a successive, batchwise fashion in order to pass the pharmaceutical particles through the coating apparatus multiple times, using the same or different coating liquid.

The present invention further concerns a related process for coating a carrier particle with a liquid comprising a pharmaceutically active ingredient, the process comprising the steps of:
(a) metering into a flow restrictor a coating liquid comprising a pharmaceutically active ingredient;
(b) injecting a gas stream through the flow restrictor concurrently with step (a) to (i) atomize the coating liquid and (ii) create turbulent flow of the gas stream, wherein the gas stream is optionally heated; and
(c) adding a carrier particle to the turbulent flow region concurrently with steps (a) and (b) wherein the carrier particle mixes with the atomized coating liquid in the region of turbulent flow, to provide a carrier particle coated with a pharmaceutically active ingredient.

The present invention further concerns a process for coating a carrier particle with a liquid comprising a pharmaceutically active ingredient, the process comprising the steps of:
(a) metering into a flow restrictor a coating liquid comprising a pharmaceutically active ingredient wherein said liquid further comprises carrier particles to be coated;
(b) injecting a gas stream through the flow restrictor concurrently with step (a) to (i) atomize the coating liquid and (ii) create turbulent flow of the gas stream, wherein the gas stream is optionally heated;

wherein the carrier particles to be coated mix with the atomized coating liquid in the region of turbulent flow, to provide a carrier particle coated with a pharmaceutically active ingredient.

The process of the invention can be used to coat any solid particulate form of pharmaceutical, or to coat any solid carrier particle with a liquid pharmaceutically active ingredient, wherein as used by Applicants for purposes of this disclosure, pharmaceuticals can be considered to include nutriceuticals, vitamins, supplements, minerals, enzymes, probiotics, bronchodilators, anabolic steroids, analeptics, analgesics, proteins, peptides, antibodies, vaccines, anesthetics, antacids, antihelmintics, anti-arrthymics, antibiotics, anticoagulants, anticolonergics, anticonvulsants, antidepressants, antidiabetics, antidiarrheals, anti-emetics, anti-epileptics, antihistamines, antihormones, antihypertensives, anti-inflammatories, antimuscarinics, antimycotics, antineoplastics, anti-obesity drugs, antiprotozoals, antipsychotics, antispasmotics, anti-thrombics, antithyroid drugs, antitussives, antivirals, anxio lytics, astringents, beta-adrenergic receptor blocking drugs, bile acids, bronchospasmolytic drugs, calcium channel blockers, cardiac glycosides, contraceptives, corticosteriods, diagnostics, digestives, diuretics, dopaminergics, electrolytes, emetics, haemostatic drugs, hormones, hormone replacement therapy drugs, hypnotics, hypoglycemic drugs, immunosuppressants, impotence drugs, laxatives, lipid regulators, muscle relaxants, pain relievers, parasympathicolytics, parasympathicomimetics, prostagladins, psychostimulants, sedatives, sex steroids, spasmolytics, sulfonamides, sympathicolytics, sympathicomimetics, sympathomimetics, thyreomimetics, thyreostatic drugs, vasodialators, and xanthines.

The invention can also be used to coat pharmaceutical particles that comprise mixtures of two or more different pharmaceuticals, or mixtures of pharmaceuticals and excipients, or other ingredients which can be added to pharmaceuticals or to coat carrier particles with liquids containing more than one pharmaceutically active ingredient.

The pharmaceutical products formulated by the claimed processes are suitable for delivery to mammals by a variety of routes of administration including, for example, oral, inhalable, trandermal, parenteral, buccal, nasal, vaginal, rectal, sub-lingual, ocular, periodontal, implantation, or topical.

This invention can be practiced using any number of liquid coating materials, examples of which comprise a starch, gelatin, a natural color, a synthetic color, a sugar, a cellulose, a biodegradable polymer, a biodegradable oligomer, an emulsifying wax, a fat, a wax, a phospholipid, a shellac, a flavoring agent, a moisture barrier, a taste-masking agent, an odor-masking agent, a shelf-life extending agent, a lipid, a protein, cellulose derivatives, alginate, chitosan, surfactants or other wetting agents, carbohydrates, natural or synthetic polymers, methacrylate polymers and co-polymers, polylactic acid (PLA), polylactide co-glyceride (PLGA), a mineral, or a liquid containing a pharmaceutically active ingredient.

Also included in Applicants' invention are the coated pharmaceutical particles made by the processes of the invention.

The invention further is directed to compositions comprised of pharmaceutical particles having a size greater than about 100 nm and less than about 100 um, that have been coated with a surface active agent, wherein the coated particles exhibit enhanced dissolution. In a preferred aspect, the particles in this composition are coated with the surface active agent from between about 0.1% to about 30% by % weight of the coating material to final weight of the composition of coated particles. Particularly preferred compositions will be comprised of particles from about 0.5 um to about 25 um, or about 1 um to about 15 um, which are coated with surface active agent from about 1% to about 30%, or about 1% to about 20%, and exhibit an enhancement in the rate of dissolution of at least about 10%, or more preferably about 200%.

Also included within this aspect of the invention are particles of ibuprofen between 100 nm and 100 um that have been coated with a surface active agent wherein said particle exhibits an enhanced rate of dissolution, particularly when the surface active agent is Poloxamer® or SLS.

### BRIEF DESCRIPTION OF THE DRAWINGS

FIG. 1 is a schematic diagram of a portion of the apparatus in accordance with the present invention.

FIG. 2 is a cut-away, expanded, cross-sectional view of a portion of the apparatus shown in FIG. 1.

FIG. 3 is an alternative configuration of the apparatus.

FIG. 4 shows scanning electron microscope (SEM) pictures of ibuprofen particles, uncoated and coated with ethylcellulose.

FIG. 5 shows dissolution profiles (pH 7.2) of tablets containing uncoated ibuprofen and coated (with ethylcellulose) Ibuprofen in pH 7.2 buffer.

FIG. 6 shows scanning electron microscope (SEM) pictures of uncoated and coated particles (with Eudragit® EPO) caffeine particles.

FIG. 7 shows Time-of Flight-Secondary Ion Mass Spectroscopy (ToF-SIMS) secondary ion maps of caffeine particles coated with Eudragit EPO.

FIG. 8 shows dissolution profiles of tablets containing caffeine from uncoated and coated (with Eudragit® EPO) caffeine particles.

FIG. 9 shows scanning electron microscope (SEM) pictures of uncoated and coated with ethyl cellulose) sodium chloride particles.

FIG. 10 shows a Time-of Flight-Secondary I(n Mass Spectroscopy (ToF-SIMS) secondary ion map of sodium chloride coated with ethylcellulose.

FIG. 11 shows conductivity profiles of uncoated and coated (with ethylcellulose) sodium chloride particles in water.

FIG. 12 shows scanning electron microscope (SEM) pictures of uncoated and coated (with Poloxamer® 188) ibuprofen particles.

FIG. 13 shows dissolution profiles (pH 5.8) of tablets containing uncoated ibuprofen and coated (with Poloxamer® 188) ibuprofen.

FIG. 14 shows dissolution profiles (0.1 N HCl) of tablets containing uncoated ibuprofen and coated (with Poloxamers® 188) ibuprofen.

### DETAILED DESCRIPTION OF THE INVENTION

All patents, patent applications, and publications referred to herein are in corporated by reference in their entirety.

In the context of this disclosure, the following terms should be accorded the meanings indicated below.

The term “coating” as used herein refers to adherence, adsorption, loading and/or incorporation, to some extent, of at least one liquid coating material onto and/or into a solid particle or particles. This liquid may remain in the liquid state, or be chilled to solidify or evaporated to leave its solute as a solid coating residue. The coating material on the pharmaceutical particle may be of any thickness; it need not necessarily be uniform on the surface of the particle, nor is the entire surface of the particle necessarily covered. As used herein, the term coating includes the concept of encapsulation, but does not necessarily imply that the coated particle has been encapsulated.

The term “size” as used herein refers to the longest diameter or longest axis of the particle being coated. Throughout the disclosure, the letter “d” or “D” denotes diameter of the particle.

This invention provides, in a first aspect, a process for coating a particle with a liquid to make a pharmaceutical particle, the process comprising the steps of metering a coating liquid into a flow restrictor and concurrently injecting a gas stream through the flow restrictor in order to atomize the coating liquid. When the gas stream passes through the restricted region of the flow restrictor, a region of turbulent flow is created. Particles are added to the turbulent flow region, wherein the particles mix with the atomized coating liquid in the region of turbulent flow and are instantly coated and dried, thereby providing a coated particle. The particles may be comprised of pharmaceutical particles or carrier particles. In the case where a carrier particle is coated, the coating liquid will contain a pharmaceutically active ingredient. The term “carrier” particle is used herein to mean that the particle itself is not a pharmaceutical.

In a related second aspect, the invention also provides an alternative embodiment of the coating process to coat a particle with a liquid. This aspect of the process entails mixing the particle to be coated with the coating liquid prior to metering the coating liquid into the apparatus used to conduct the process of the invention. Specifically, this aspect comprises the steps of metering a coating liquid containing particles to be coated into a flow restrictor; injecting a gas stream through the flow restrictor to create turbulent flow of the gas stream as it emerges from the constricted portion of the flow restrictor, thereby atomizing the coating liquid; wherein the particles mix with the atomized coating liquid in the region of turbulent flow to provide dry, coated pharmaceutical particles. In this aspect the particles to be coated may be pharmaceutical particles, or carrier particles, in which case the liquid coating comprises a pharmaceutically active ingredient.

Thus, in the processes of the present invention, unlike a fluidized bed process in which the particles to be coated are recirculated within the bed to ensure a prolonged residence time in the treating vessel in order to obtain adequate coating, the process of the invention is practiced without the need for such recirculation, or a prolonged exposure of the particles to the coating liquid during the drying phase of the process. The process of the invention is distinguished from the prior art in that the particle experiences an extremely short residence time in the region in which coating occurs.

In another aspect, the above-described processes further comprise repeating the coating process, in a batchwise fashion, at least once, wherein the coating material may be the sa me or different. Thus, particles, for example, can be coated with a succession of coating materials of the same liquid or various combinations of materials such as acrylic based polymers, pharmaceutical liquids, color, sugar, and other flavorings, etc., thus enabling unique combinations of moisture barriers, taste-masking agents, odor-masking agents, shelf-life extending agents, etc., to coat the particles. Multiple coatings thus applied can lead to uniquely tailored pharmaceutical particles with desired colors, flavor-masking, solubility, wettability, dispersion characteristics, and shelf-life aspects; each coating having the ability to retain its original integrity and function in that in the first aspect of the process there is minimal “mixing” of subsequent layers that are applied to the dry pharmaceutical particles.

A particularly beneficial aspect of the process is that particles can conveniently be successively coated in a batchwise manner, enabling the process to yield pharmaceutical particles having a controlled thickness of the coating material. It is believed that a particle coated successively with several thin layers of a coating material will have different characteristics than a particle coated with the same total amount of that coating material applied in a single application.

There are other potential advantages in having the ability to control the thickness of the coating that is applied to particles. For example, when taste masking or stability of the particles is the goal, it is often advantageous to have the ability to apply a maximum amount of coating material to the particles, and successive, multiple batchwise application is an effective means to accomplish this goal. Conversely, it is often advantageous to apply surface modifying coating materials such that the weight percent of the surface modifying material to the total drug particles is minimized. For example, in some situations it is believed that the coating material may adversely affect efficacy or stability characteristics of the pharmaceutical active. This is particularly evident when coating materials are applied in an effort to achieve surface modification of the particles, for example, to enhance solubility, rate of release, wettability, flowability, fluidizability, restrict agglomeration, etc. of the particles. In these situations, the goal is to apply a minimum amount of the coating material to achieve the desired effect, in order that any potentially negative effects of the coating agent on the pharmaceutical active are minimized. Applicants' process is uniquely suited to these situations for a variety of reasons. The process of the invention applies atomized liquids to the surface of particles in a zone of turbulence wherein there is essentially uniform, instant dispersion and drying of the particles. Thus, the physical characteristics of the final coated particles are distinct from conventional pharmaceutical coating processes which rely on simply a mixing and subsequent drying of the coating material and the particles, such as in wet granulation and fluid bed granulation. In fluid bed coated products, the physical form of the final product often resembles simply a dried granular product which can physically be a mixture of the dried coating particles and the pharmaceutical active particles. In contrast, Applicants' coated composition is believed to consist of discreetly coated drug particles, wherein the coating material adheres to the particle.

There are several further potential benefits of the instant process. Applicants believe the process of the invention can be more cost efficient on a large scale than currently conducted pharmaceutical coating processes, which commonly depend upon spray drying, spray chilling, spinning disc coating, extrusion, fluid bed, spray pan coating, or coacervation techniques. Regarding the first aspect of the invention particularly, overall pharmaceutical quality can be improved over conventional techniques since this is a dry coating process, wherein the liquid coating and drying step occur during the same pass of the pharmaceutical particle through the apparatus of the invention. Individual particles are exposed to coating agents during the process for only tens to hundreds of milliseconds, while in conventional techniques exposure time is measured in minutes to hours. There is reduced time of liquid residence on the particle, resulting in reduced opportunity for microbial contamination and other degradation associated with exposure to liquid during the coating process. Thus, efficiency in rate of coating and residence time in the coating process for the coated particles are significant benefits in Applicants' process. Overall pharmaceutical quality is also potentially improved in that pharmaceutical particles that have been coated with the instant process have been observed in most cases to retain their morphology, structural integrity, and particle size throughout the process.

Flexibility is inherent in the operation of the apparatus an d process of the invention and can result in production of coated pharmaceutical particles that have controlled and unique characteristics. For example, concentration values of the coating liquid, flow rates of the solid particle feed and the liquid feed, ratios of the liquid feed to solid feeds, and temperature and velocity of the gas streams can all be easily varied to yield coated pharmaceutical particles with particular desired characteristics.

Any particle with structural integrity as a particle can be coated using the process of the invention. Examples of such particles include, but are not limited to, vitamins, supplements, minerals, enzymes, proteins, peptides, antibodies, vaccines, probiotics, bronchodilators, anabolic steroids, analeptics, analgesics, anesthetics, antacids, antihelmintics, anti-arrthymics, antibiotics, anticoagulants, anticolonergics, anticonvulsants, antidepressants, antidiabetics, antidiarrheals, anti-emetics, anti-epileptics, antihistamines, antihormones, antihypertensives, anti-inflammatories, antimuscarinics, a ntimycotics, antineoplastics, anti-obesity drug s, antiprotozoals, antipsychotics, antispasmotics, anti-thrombics, antithyroid drugs, antitussives, antivirals, anxiolytics, astringents, beta-adrenergic receptor blocking drugs, bile acids, bromchospasmolytic drugs, calcium channel blockers, cardiac glycosides, contraceptives, corticosteriods, diagnostics, digestives, diuretics, dopaminergics, electrolytes, emetics, haemostatic drugs, hormones, hormone replacement therapy drugs, hypnotics, hypoglycemic drugs, immunosuppressants, impotence drugs, laxatives, lipid regulators, muscle relaxants, pain relievers, parasympathicolytics, parasympathicomimetics, prostagladins, psychostimulants, sedatives, sex steroids, spasmolytics, sulfonamides, sympathicolytics, sympathicomimetics, sympathomimetics, thyreomimetics, thyreostatic drugs, vasodialators, and xanthines. Further, in the case that inert or carrier particles are coated with liquids comprising the pharmaceutically active ingredient, any particle that is suitable for the intended patient and route of delivery can be used. For example, lactose or other carbohydrate particles, and titanium dioxide or silica particles, for example, would be suitable for use in the process of the invention to create pharmaceutical particles for inhalation or ingestion in many instances. By the terms inert or carrier particles, Applicants mean any substance not comprised of a pharmaceutically active material that is safe for use in the delivery route contemplated for that coated pharmaceutical.

The particles of the invention can also be comprised of mixtures of two or more different pharmaceutical compounds, or mixtures of pharmaceutical compounds with excipients, carriers and other formulation substances. Combination therapies are becoming of significant interest in simplifying treatment of diseases as well as enabling defendable new drug products. The coating device could be used in such a fashion to enable multiple drugs to be in a single particle (discrete coated particle or as an agglomerate particle). For a discrete coated particle, for example, a sinus/influenza treatment could be prepared by feeding a solid stream of acetaminophen particles to the coating device and concurrently a liquid stream of a solution of pseudoephedrine. This would enable a core shell structure of a single discrete drug particle where the pseudoephedrine was coated onto the surface of the acetaminophen drug crystal. This particle could be further protected by applying a tastemasking polymer/flavor material and/or a sustained release polymer (eg Eudragite®).

For an agglomerate particle of a combination therapy, for example, a single particle of acetaminophen could be fed as the solids stream to the coating device. Concurrently, pseudoephedrine could be fed as a slurry to the liquid feed stream of the coating device. The pseudoephedrine crystals could be made as a slurry in an appropriate solvent, also containing a binding agent (eg hydroxypropylmethyl cellulose). The binder would enable the pseudophedrine crystals to be fixed to the outer surface of the acetaminophen drug crystals. Further coating treatments would also be feasible for example for taste masking, controlled release, targeted delivery, etc.

Particles of the invention can be purchased commercially, or they can be produced and processed to be of desired sizes and characteristics using conventional synthesis and particulate technology. The general size range of particles suitable for use in the process of the invention will range from about 5 nm to about 15 mm; although the preferred size range will be determined according to the intended use of the particle. Further, the physical characteristics of the particles selected will be determined by the type of coating desired to be achieved in the process. For example, porous particles may be selected if it is desired to impregnate the particle with the coating material. Solid crystallizine particles of a drug may be selected, in a desired size range, to be coated with a surface modifying agent, or a taste masking agent, for example. It will also be apparent to those skilled in this art, for example, that inert carrier particles such as silica or titanium dioxide could be coated using the process of the invention with a liquid coating comprising a pharmaceutically active ingredient. Thus, inert or carrier particles could be used as particulate delivery aids in formulating useful pharmaceuticals. To one skilled in the art of pharmaceutical delivery, it will be apparent that the process of the invention can be tailored such that many forms and types of solid particles will be suitable for coating with many forms of liquid materials, resulting in a finally coated product suitable for use as a pharmaceutical.

Crystallization and milling are two methods currently used to produce pharmaceutical compounds, and in this aspect Applicants herein incorporate by reference the following commonly-assigned patent applications which relate to methodology for producing pharmaceutical particles of varying size and purity: utility patent application filed May 2002, U.S. Appln. Ser. No. PCT/US02/16159 entitled High Pressure Media Mill; utility patent application filed Oct. 17, 2002, U.S. application. Ser. No. 10/272764 entitled Rotor-Stator Mixer Crystallization Process and Apparatus; utility patent application attorney docket number CL 1980 filed Dec. 14, 2001, U.S. application. Ser. No. 10/320245 entitled Methods and Apparatus for Crystallization; and utility patent application filed Apr. 2, 2002, U.S. application. Ser. No. 10/405436, entitled Apparatus and Process Used in Growing Crystals.

Many liquid coating materials can be used in the process of the invention. In the context of the invention, the term “liquid” refers to the state of the coating material as it is applied to the particle The finally-coated particle, when the particle is at the temperature and other conditions for delivery, may comprise a coating material in either a solid or liquid state. Coating materials include a starch, gelatin, a natural food color, a synthetic food color, a sugar, a cellulose, a biodegradable polymer, a biodegradable oligomer, an emulsifying wax, a shellac, a flavoring agent, a moisture barrier, a taste-masking agent, an odor-masking agent, hydrophobicity or hydrophilicity agents, a shelf-life extending agent, a lipid, a protein, or a mineral. Specific coating ingredients can include, for example, ethyl cellulose, methyl cellulose, hydroxypropylcellulose, polyvinylpyrolidone, polyethylene, Aquateric, Eudragit™ (including any commercial grade or formulations), acrylic coatings, Surelease™, bubble gum flavor, cherry flavor, grape flavor, sodium lauryl sulfate, sodium docusate, poly lactic acid, polylactide glycolic acid, cellulose acetate pthalate. Further, the following materials comprise suitable coating materia Is for certain applications, including as diluents: lactose, microcrystalline cellose, mannitol, dicalcium phosphate, starch, dextrates, sucrose; and as disintegrants: croscarmellose sodium, sodium starch glycolate, starch; and as binders: hydroxypropyl cellulose, hydroxypyroylmethylcellulose, povidone, methyl cellulose; and as glidants/lubricants: silicon dioxide, stearic acid, a hydrocolloid, a monosaccharide, a disaccharide, an oligosaccharide, a polysaccharide, a surface modifying agent, a sugar alcohol, a poly-ol, a flow aid, an interparticle force control agent, magnesium stearate, talc, sodium stearyl fumarate; and as surfactants: Tween 80; polysorbate , polyethylene glycol 400, Poloxamer®, glycol 3350, sodium lauryl sulfate (SLS), lecithin, oleic acid, polyoxyethylene alkyl ethers, Cremophor EL, Cremophor RH, polyoxyethlene stearates, sorbitan fatty acid ester; and as coating ingredients: hydroxypropyl cellulose, hydroxypropylmethylcellulose, titanium dioxide, colors, polyethylene glycols, triethyl citrate, triacetin, dibutyl sebacate and polymethacrylates.

Further, the coating material can be a dispersion of one or more compounds. For example, a coating dispersion may contain a polymer such as ethylcellulose and a plasticizer such as triethyl citrate dissolved in a suitable solvent and talc added as an antitackifier. Solvents that can be used in the process include water, acetone, ethanol, methanol, ethyl acetate, isopropyl alcohol, methyl acetate, n-propanol, ketones, toluene and methylene chloride, for example. A dispersion is defined herein as a two-phase system of which one phase consists of finely divided particles (often in the colloidal size range) distributed throughout a bulk substance, the particles being the disperse or internal phase and the bulk substance the continuous or external phase. Under natural conditions the distribution is seldom uniform, but under controlled conditions the uniformity can be increased by addition of wetting or dispersing agents (surfactants) such as a fatty acid. Examples of dispersions include liquid/liquid (emulsion) and solid/liquid (paint).

In the aspect wherein a drug active is used as a constituent in the coating agent liquid/solution/slurry/dispersion or emulsion, the particle selected for coating may be a drug particle or an inert carrier particle of a porous or nonporous nature. One example of this could be in the area of dry powder delivery of inhalable drug compounds. For example the coating device could be fed a solids stream of 2 micron lactose carrier particles and a liquid stream of a solution of albuterol (an asthma drug). The lactose core particles could be coated up to 3 microns diameter (for instance), where the coated shell contained the active albuterol drug. This concept could enable a standard design (or formulation) of dry powder inhalable pharmaceutical compound, wherein the standard desired particle size for such applications is 1 to 5 microns. Further to this, the active drug shell coating on the lactose excipient carrier particle could be further coated with a surface modifier such as poly lactic acid to give it improved deagglomeration properties in the inhaler device and/or controlled release properties of the drug substance delivered to the lung.

It is believed that the process of the invention has aspects rendering it particularly suitable for the preparation of inhaled pharmaceuticals. For example, the process of the invention can be used to modify the surface of particles in the inhalable range of 1-5 microns so that such particles can be more readily dispersed by dry powder, resulting in a higher respirable fraction. Further improved flowability for processing and filling of suspension metered dose inhaler (MDI) products can be achieved. Further, the process is suitable to achieve intimate mixing of surfactants (such as oleic acid or soya lecithin) onto inhalable powders.

In another aspect, this invention includes coated pharmaceutical particles made using the process of this invention.

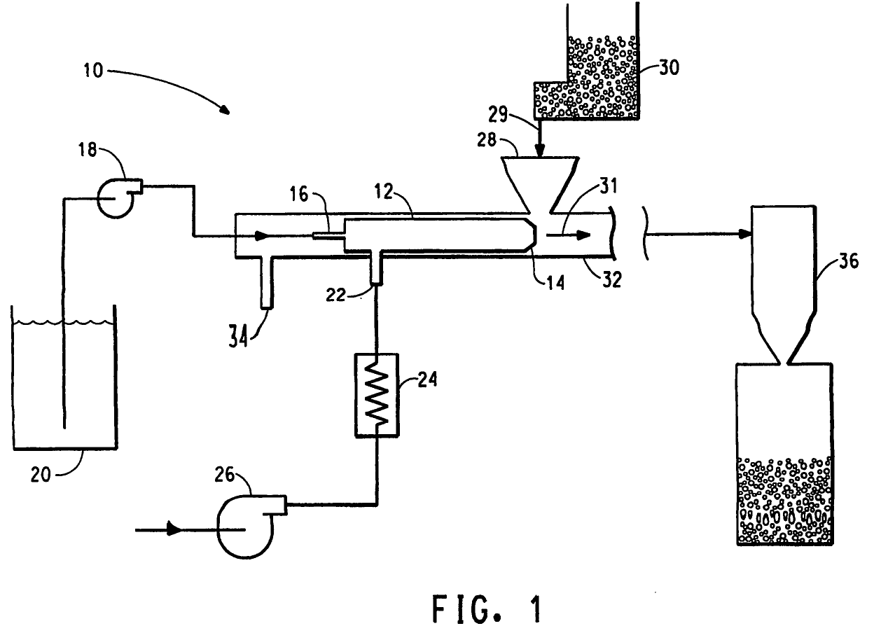

An apparatus used to practice the process of this invention is generally described in commonly owned PCT application WO 97/07879. An apparatus according to the present invention is shown generally at 10 in FIG. 1.

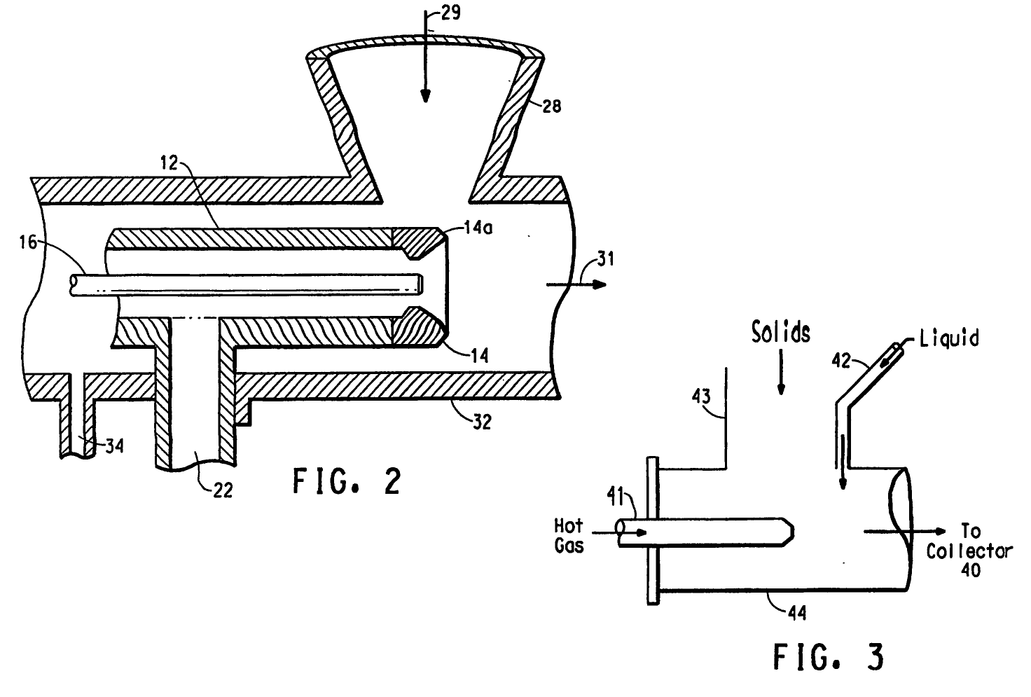

An apparatus useful in the present invention comprises a first chamber, shown at 12 in FIGS. 1 and 2. A flow restrictor 14 is disposed at one end of the first chamber. The flow restrictor is typically disposed at the downstream end of the first chamber, as shown in FIGS. 1 and 2. Flow restrictor 14 has an outlet end 14a, as shown in detailed view of FIG. 2. Although the flow restrictor is shown as a different element from the first chamber, it may be formed integrally therewith, if desired. The flow restrictor of the present invention may have various configurations, as long as it serves to restrict flow and thereby increase the pressure of the fluid passing through it. Typically, the flow restrictor of the present invention is a nozzle.

A first, or liquid, inlet line 16 as shown FIGS. 1 and 2 is disposed in fluid communication with the first chamber for metering a liquid composition into the chamber. Liquid inlet line 16 meters the liquid composition into the first chamber 12 in the outlet flow restrictor 14, and preferably in the center of the flow restrictor when viewed along the axial length thereof. The liquid composition is metered through liquid. inlet line 16 by a metering pump 18 from a storage container 20 containing the liquid corn position as shown in FIG. 1.

The liquid coating composition may be a solution, a slurry, a dispersion, an emulsion or a melt. By melt is meant any substance at a temperature at or above its melting point, but below its boiling point. In any of these cases, the liquid composition may include components other than the coating material. It should be noted that when the liquid composition is a melt, storage container 20 must be heated to a temperature above the melt temperature of the liquid composition in order to maintain the liquid composition in melt form.

The disclosed apparatus for coating a particle further includes a second, or gas, inlet line 22 disposed in fluid communication with the first chamber as shown in FIGS. 1 and 2. Generally, the gas inlet line should be disposed i n fluid communication with the first chamber upstream of the flow restrictor. Gas inlet line 22 injects a first gas stream through the flow restrictor to create a region of turbulent flow, referred to here as a zone of turbulence, at the outlet of the flaw restrictor. The turbulence subjects the liquid composition to shear forces that atomize the liquid composition.

The first gas stream should have a stagnation pressure sufficient to accelerate the gas to at least one-half the velocity of sound, or greater, prior to entering the flow restrictor to ensure that a zone of turbulence of sufficient intensity will be formed at the outlet of the flow restrictor. The velocity of sound for a particular gas stream, e.g., air or nitrogen, will be dependent on the temperature of the gas stream. This is expressed by the equation for the speed of sound, C:
C=\sqrt{kgRT}

where:
k=ratio of specific heat for the gas
g=acceleration of gravity
R=universal gas constant
T=absolute temperature of the gas

Thus, the acceleration of the first gas stream is dependent on the temperature of the gas stream.

As noted above, it is the pressurized gas that causes the atomization of the liquid composition. The pressure of the liquid composition in the liquid inlet line just needs to be enough to overcome the system pressure of the gas stream. It is preferable that the liquid inlet line has an extended axial length before the zone of turbulence. If the liquid inlet line is too short, the flow restrictor becomes plugged.

The apparatus disclosed for purposes of demonstrating the present invention also comprises means disposed in the second inlet line and upstream of the flow restrictor for optionally heating the first gas stream prior to injection through the flow restrictor. Preferably, the heating means comprises a heater 24 as shown in FIG. 1 . Alternatively, the heating means may comprise a heat exchanger, a resistance heater, a in electric heater, or any type of heating device. Heater 24 is disposed in second inlet line 22. A pump 26 as shown in FIG. 1 conveys the first gas stream through heater 24 and into first chamber 12. When a melt is used as the coating material, the gas stream should be heated to a temperature around the melt temperature of the melt, to keep the melt in liquid (i.e., melt) form. When using a melt, it is also helpful if auxiliary heat is provided to the first inlet line that supplies the melt prior to injection, to prevent pluggage of the line.

An apparatus of the present invention further includes, in the first aspect of the process, a hopper 28 as shown in FIGS. 1 and 2. Hopper 28 introduces a particle to the zone of turbulence. It is preferable that the outlet end of the flow restrictor is positioned in the first chamber beneath the hopper at the center line of the hopper. This serves to ensure that the particles are introduced directly into the zone of turbulence. This is important because, as noted above, the turbulence subjects the liquid composition to shear forces that atomize the liquid composition It also increases operability by providing a configuration for feeding the particles most easily. In addition, the shear forces disperse and mix the atomized liquid composition with the particles, which allows the particles to be coated. Hopper 28 may be fed directly from a storage container 30 as shown by arrow 29 in FIG. 1. The hopper of the present invention may include a metering device for accurately metering the particles at a particular ratio to the liquid feed from liquid inlet line 16 into the zone of turbulence. This metering establishes the level of coating on the particle. Typically, the hopper of the present invention is open to the atmosphere. When a melt is used, it is preferred that the particles are at ambient temperature because this facilitates solidification of the melt after the melt that is initially at a higher temperature coats the particle in the zone of turbulence. In the second aspect of the process wherein the particles are delivered to the coating apparatus contained in the coating material, hopper 28 is not used and is sealed from the apparatus.

The apparatus used to disclose the present invention may further include a second chamber 32 surrounding the first chamber as shown in FIGS. 1 and 2. In addition, the second chamber encloses the zone of turbulence. Second chamber 32 has an inlet 34 for introducing a second gas stream into the second chamber. The inlet of the second chamber is preferably positioned at or near the upstream end of second chamber 32. The outlet of second chamber 32 is connected to a collection container, such as that shown at 36 in FIG. 1. The second gas stream cools and conveys the coated particles toward the collection container as illustrated by arrow 31 in FIG. 2. In particular, when a solution or slurry is used, the solid of the solution or slurry cools between the zone of turbulence and container so that by the time the particle reaches the container, a solid coating comprising the solid of the solution or slurry is formed on the particle. When a melt is used, the liquid composition cools in the zone of turbulence so that by the time the particle reaches the container, a solid coating comprising the melt is formed on the particle. The first gas stream, as well as the second gas stream, is vented through the top of collection container 36.

Thus, unlike a fluidized bed processes in which the particles to be coated are recirculated within the bed to ensure a prolonged residence time in the treating vessel in order to obtain adequate coating, the process of the invention is practiced without the need for such recirculation. The residence time of the particles in the zone of turbulence is determined by the geometry of the first chamber and the amount of gas injected from the gas inlet line. The average residence time of the particle within the zone of turbulence is preferably less than 250 milliseconds. More preferably, the average residence time of the particle within the zone of turbulence is in the range of 25 to 250 milliseconds. Short residence times can be achieved because of the action of the zone of turbulence. The short residence times make the process of the present invention advantageous compared to conventional coating processes because the time, and hence, the cost of coating particles, are reduced.

For the configuration as shown in FIGS. 1 and 2, inlet 34 may be connected to a blower, not shown, which supplies the second gas stream to the second chamber. The blower and second chamber 32 may be eliminated, however, and the first gas stream may be used to cool the particles and to convey the m to container 36. In this case, the solid from the solution, slurry, or melt cools and solidifies on the particle in the atmosphere between the zone of turbulence and the collection container, and the coated particles fall into collection container 36.

It is preferable that the axial length of the zone of turbulence is about ten times the diameter of the second chamber. This allows the pressure at the outlet of the flow restrictor to be at a minimum. In the first aspect of the process the articles are fed into second chamber 32 as shown in FIGS. 1 and 2 near the outlet of the flow restrictor, which is preferably positioned at the center line of the hopper. If the pressure at the outlet is too great, the particles will back flow into the hopper.

A convective drying process can be used for removing residual volatiles that result from putting a solution, slurry, or emulsion coating onto the surface of a pharmaceutical particle. Generally, the coated particle exits the process of the invention as a dry and disperse product with the same particle size as the substrate plus coating thickness. In cases where the structural integrity of the particle is not great enough to withstand the forces in the zone of turbulence, however, particle size and shape of the final particles emerging from the process may be affected.

The design of the process tends to preclude wet particles from reaching any wall to which they may stick, which improves the cleanliness of the system, and may also include a recycle system that can reduce any interparticle or particle-to-wall sticking that might otherwise occur. This process may be selected from any number of methods, including but not limited to flash drying, pneumatic conveyor drying, spray drying, or combinations thereof. Residence times for drying are generally less than a minute and preferably in the millisecond time frame.

The coating materials are generally liquid in nature and can be single or multiple chemical compositions. Thus, they may be pure liquids, solutions, suspensions, dispersions, emulsions, melted polymers, resins, and the like. These materials generally have viscosities in the 1 to 2,000 centipoise range. Coatings that are applied can be hydrophilic, hydrophobic, or amphoteric in nature, depending on their chemical composition. When more than one coating is app lied, it can be either as another shell adhering to the previous coating, or as individual particles on the surface of the material to be coated. These materials may also be reactive so that they cause the material they are coating to increase in viscosity or change to a solid or semi-solid material.

It should be noted that the process of the present invention may be practiced using the apparatus illustrated in FIGS. 1, 2, and 3, although it should be understood that the process of the present invention is not limited to the illustrated apparatus. For example, the apparatus of FIGS. 1 and 2 can have an alternate configuration, as seen in FIG. 3. Solids could enter the apparatus through hopper 43. Liquid is added via a liquid inlet tub 42 located at the top of the apparatus so that the liquid exists into the high shear/turbulence zone. Hot gas enters chamber 44 through nozzle 41. Produce outlet from chamber 44 exits to collector 40. This configuration can allow for faster changes of liquid used for coating and is less expensive to maintain.

A further aspect of the invention relates to particles having unique dissolution functionalities due to application of surface active agent onto the surface of the particles. Applicants herein disclose particles demonstrating significantly enhanced dissolution ability over previously known pharmaceutical particles. Applicants attribute this unique functionality to the ability of the claimed process to discreetly coat surface active agents onto the surfaces of individual particles. In this aspect of the invention, the term “enhanced” as relating to dissolution refers to a measurable increase in the rate of dissolution compared to the rate of dissolution of particles that have not been coated with surface active agent. Preferably, the coated particles exhibit at least a 10% increase in the rate of dissolution over uncoated particles, m ore preferably a 50% increase, more preferably a 200%, more preferably a 500% and most preferably a 1000% increase in rate of dissolution over uncoated particles.

In this aspect of the invention, a “surface active agent” is defined by Applicants to include surfactants, emulsifiers and solubilizing agents that acts to reduce surface tension when dissolved in water or aqueous solutions, or that reduce interfacial tension between two liquids, or between a liquid and a solid. In this art there are three recognized categories of surface active agents: detergents, wetting agents and emulsifiers; all use the same basic chemical mechanism and differ chiefly in the nature of the surfaces involved. Examples of surface active agents include, but are not limited to, polysorbates, polyethylene glycols, sodium lauryl sulfate (SLS), lecithin, oleic acid, Poloxamero®, Tween, polyoxyethylene alkyl ethers, Cremophor EL, Cremophor RH, polyoxyethylene stearates and sorbitan fatty acid esters.

Within this aspect of the invention the useful range of application of surface active agents to particles is believed to be from about 0.1%o to about 30%; or preferably from about 1% to about 20%; or more preferably from about 1% to about 10%, by total weight of the applied surface active agent to final weight of the composition of coated pharmaceutical particles.

Within this aspect of the invention the size of pharmaceutical particles having the surface active agent coated thereon will be from about 100 nm to about 100 um; preferably from about 0.5 um to about 25 um; and most preferably from about 1 um to about 15 um. Size refers to an average starting size of the uncoated pharmaceutical particles to be coated, wherein the average size measurement will be referred to as the d 50 or D50 size.

Particularly preferred aspects of this aspect of the invention: include, for example, ibuprofen particles that have been coated with surface active agents such as Poloxamer® or SLS.

### EXAMPLES

The invention is further described by the following examples, which are provided for illustration and are not to be construed as limiting the scope of the invention.

Unless otherwise specified, all chemicals and reagents were used as received from Aldrich Chemical Co., Milwaukee, Wis.

The following materials were used in the examples below:
Eudragit® RL 30D acrylic polymer and Eudragits® EPO, Rohm America, LLC, Piscataway, N.J.;
Capsugel® two piece capsules, Pfizer, Inc., Greenwood, S.C.;
Poloxamer® 188, Fruit-Eze, Inc., Portland, Oreg.; also available from Spectrum Chemical Co., Gardena, Calif.
Aquateric® micronized CAP containing 66-73% CAP, a polyoxyethylene-polyoxyoropylene block co-polymer and distilled acetylated monoglycerides, FMC Corporation, Philadelphia, Pa.;
Surelease® aqueous ethylcellulose dispersion, ColorCon, West Point, Pa.
Tween 80 non-ionic surfactant, EM Science, Gibbstown, N.J.

### Examples 1

Samples of Ibuprofen, USP (Spectrum Chemical Co., Gardena, Calif.) were coated using the apparatus as shown in FIG. 1. The apparatus had a mixing chamber 3.18 cm in diameter arid 19.05 cm in length with a nozzle throat of 1.02 cm and a central liquid feedtube of 0.39 cm in diameter. The apparatus has a single screw metering feeder (AccuRate, Whitewater, Wis.) for metering the solid particles. A peristaltic pump (Cole-Parmer, Vernon Hills, Ill.) was fit with 6.5 mm Tygon™ elastomer tubing for metering the liquid. Ibuprofen was metered to the system (51.3, 71.6, 120.5 g/min). Eudragit®R RL30D at 22° C. ambient temperature was metered in a range of (27.0, 28.1, 30.4 g/min) to the center tube. The heated gas pressure at the nozzle was 551 kPa and the temperature was at 125° C. at the nozzle. The nitrogen gas This pressurized air was used to atomized the Eudragit® RL30D, producing a negative pressure in the mixing zone to induce the addition of the Ibuprofen, and to provide the heat for evaporating any residual moisture from the ibuprofen. The product of the mixing/drying was conveyed down a 0.35 m tube to a cyclone to enable collection of the product. The product samples had a Eudragit® RL30D mass fraction of (7.0%, 10.5%, 13.6% w/w).

After processing, the Eudragit® RL30D coated ibuprofen particles were drymixed 1:1 with an excipient (microcrystalline cellulose, FMC Corp., Philadelphia, Pa.) and filled into Capsugel 00 hard gelatin capsules (Capsugel, Greenwood, S.C.) such that each capsule contained 200 mg of ibuprofen. The content uniformity was assessed on three units per formulation according to the USP method. Briefly, the USP method involved emptying the entire contents of a capsule into an appropriate container, then mixing with 17.0 mL of internal standard solution, followed by shaking for 10 minutes and finally centrifugation prior to concentration analysis. The USP assay method is a high performance liquid chromatographic method with UV spectrophotometric detection at 254 nm. The monograph specifies a 4.6 mm×25 cm column with L1 packing; the column used was a Zorbax® ODS column (Agilent, Palo Alto, Calif.) with 5 micron particles. The mobile phase is a 60/40 mixture of acetonitrile and 1% chloroacetic acid solution (pH of the 1% chloroacetic acid adjusted to 3.0 prior to combining with the acetonitrile.) Valerophenone is used as an internal standard in the quantitation of results.

Dissolution profiles were measured using apparatus 2, since the dosage units being tested in this instance were in the form of capsules, The test methods were based on the USP monograph for ibuprofen tablets (USP 25 pp. 884-887) with some modifications made to accommodate the capsule versus tablet dosage form. Dissolution testing was performed in two dissolution media in addition to the pH 7.2 phosphate buffer specified in the USP monograph. The other two acidic media were: (i) 0.1 N HCI; and (ii) pH 3.6 citrate buffer medium for formulation development purposes. Capsule assays indicated an acceptable content uniformity (for 7.0% coating RSD=10.2%, for 10.5% coating RSD =2.5%, for 13.6% coating RSD=2.2%). In addition a control capsule formulation was prepared containing 1:1 unprocessed ibuprofen with microcrystalline cellulose excipient. The content uniformity of this control capsule formulation was RSD=0.4%. USP-type stainless steel sinkers were employed to keep the product from floating when first introduced into the vessels. The vessel volume was 900 mL and the paddle speed was 50 rpm for all the media in which samples were tested. All samples at various dissolution time points samples were analyzed on a by UV spectrophotometer at about 221 nm. In the case of the acidic medium and the pH 3.6 citrate buffer medium, reference standard could not be prepared using dissolution medium due to poor solubility Depending on the ambient temperature, an amount of methanol equivalent to 20-30% of the total volume of diluent had to be used in order to dissolve the ibuprofen reference material and keep it in solution. The USP assay method is a high performance liquid chromatographic method with UV spectrophotometric detection at 254 nm. The monograph specifies a 4.6 mm×25 cm column with L1 packing; the column used was a Zorbax® ODS column with 5 micron particles. The mobile phase is a 60/40 mixture of acetonitrile and 1% chloroacetic acid solution (pH of th e 1% chloroaceticacid adjusted to 3.0 prior to combining with the acetonitrile.) Valerophenone is used as an internal standard in the quantitation of results. Table 1 below gives the % dissolved over time as well as ‘infinity’, which is achieved by increasing the agitator rate to 200 rpm following the 60 minute sample and measuring solute ibuprofen concentration after 15 further minutes.

TABLE 1

| | % Label Claim Dissolved (Mean of 6 Vessels) | | | | | |
|---|---|---|---|---|---|---|
| | 7 min | 15 min | 30 min | 45 min | 60 min | Infinity |
| pH 7.2 | | | | | | |
| Formulation | | | | | | |
| Eudragit RL 30 coating | | | | | | |
| level (% w/w) on | | | | | | |
| ibuprofen | | | | | | |
| 0% Control | 67 | 88 | 93 | 95 | 96 | 102 |
| 7.00% | 2 | 18 | 39 | 48 | 62 | 96 |
| 10.20% | 3 | 19 | 39 | 52 | 61 | 80 |
| 13.60 | 2 | 17 | 37 | 50 | 61 | 91 |
| Acidic medium 0.1 N HCl | | | | | | |
| Formulation | | | | | | |
| Eudragit RL 30 coating | | | | | | |
| level (% w/w) on | | | | | | |
| ibuprofen | | | | | | |
| 0% Control | 1 | 9 | 15 | 18 | 20 | 24 |
| 7.00% | 0 | 2 | 4 | 7 | 8 | 19 |
| 10.20% | 0 | 2 | 6 | 9 | 12 | 19 |
| 13.60 | 0 | 0 | 3 | 5 | 7 | 18 |
| pH 3.6 citrate buffer | | | | | | |
| Formulation | | | | | | |
| Eudragit RL 30 coating | | | | | | |
| level (% w/w) on | | | | | | |
| ibuprofen | | | | | | |
| 0% Control | 1 | 12 | 23 | 27 | 30 | 32 |
| 7.00% | 0 | 1 | 4 | 8 | 12 | 25 |
| 10.20% | 0 | 1 | 4 | 9 | 13 | 23 |
| 13.60 | U | 1 | 6 | 10 | 13 | 25 |

The data in all three media indicate that Eudragit® RL30D coated ibuprofen formulations showed a delayed release time of ibuprofen as determined by in vitro dissolution methods. In this instance, the three levels of coating did not have a significant correlation with the rate of release or delay of release. That is, each coated formulation exhibited approximately the same degree of delayed release, which in each instance was significantly different to the control formulation.

### Example 2

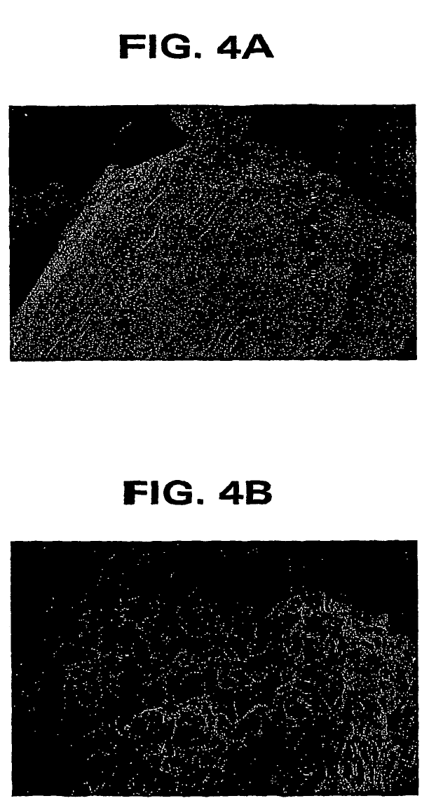

Ibuprofen, USP (Spectrum Chemical Manufacturing Co., Gardena, Calif.) was coated using the apparatus as shown in FIG. 1. The apparatus had a mixing chamber of either 2.54 cm in diameter and 19.05 cm long or 3.18 am in diameter and 43.18 cm long with a nozzle throat of diameter between 0.64 cm and 1.02 cm and a central liquid feedtube diameter between 0.18 cm and 0.39 cm. The apparatus has a single screw metering feeder (AccuRate) for metering the solid particles. In this experiment, ibuprofen was fed at a rate of 300-400 g/min. A peristaltic pump (Masterflex model 5718-10 Cole-Parmer, Vernon Hills, Ill.) was fitted with either Masterflex LS/25 (4.8mm I.D) or LS/16 (3.1 mm I.D) Tygon® elastomer tubing for metering the liquid. Ethylcellulose (Ethocel Standard, Premium; Dow Chemical Co., Midland. Mich.) was dissolved in acetone to form a coating solution. In some cases, triethyl citrate (used as a plasticizer; Spectrum Chemical Co., Gardena, Calif.), was also dissolved in the solution. The coating solution at room temperature was metered in a range of 20-30 g/min to the center tube. Heated nitrogen gas was used to atomize the coating solution producing a negative pressure in the mixing zone to induce the addition of the Ibuprofen, and to provide the heat for evaporating the solvent. The product of the mixing/evaporation was conveyed through the mixing chamber to a cyclone to enable collect ion of the product. The product was passed repeatedly through the apparatus using the same process conditions as mentioned in this example. The final product samples had a theoretical coating mass fraction between 10-13% w/w. FIG. 4 shows scanning electron micrographs of coated and uncoated particles. The particle size distribution of the uncoated and coated ibuprofen is shown in Table 2. D16, D50 and D84 represent sizes in micrometers based on cumulative volume distribution at 16%, 50% and 84%, respectively.

TABLE 2
Particle size distribution of coated
and uncoated ibuprofen samples

| | Particle Size in Microns | | |
|---|---|---|---|
| | D16 | D50 | D84 |
| Uncoated | 6.005 | 19.87 | 39.86 |
| Coated | 12.84 | 38.50 | 191.1 |

Particle size of the coated particles indicates that there is some agglomeration leading to larger particles. Agglomeration during the coating process depends mainly on the nature of the coating material.

The uncoated and coated powders were directly-compressed separately into a 200 mg strength tablet after blending with fillers, disintegrant, and lubricant (mannitol, Roquette America Inc., Gurnee, Ill.) and microcrystalline cellulose (FMC Corp., Philadelphia, N.J.) were used as fillers, croscarmellose sodium (FMC Corp., Philadelphia, N.J.) as disintegrant and magnesium stearate (Mallincrockrodt, St. Louis, Mo.) as lubricant. Powders were blended using a Turbula mixer (Glen Mills, Inc, Clifton, N.J.). The blend was compressed into tablets using a carver press (Carver Inc., Wabash, Ind.). The dissolution was performed in pH 7.2 phosphate buffer using USP apparatus 2 at 50 rpm. Samples were withdrawn at predetermined intervals and analyzed using an UV spectrophotometer at a wavelength of 221 nm.

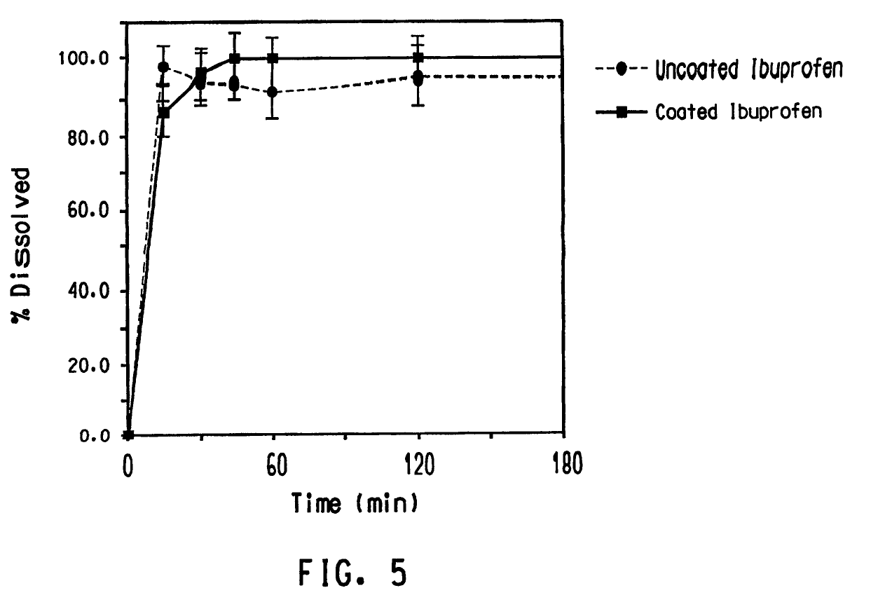

Under the experimental conditions described above, there was no significant difference in the dissolution of coated ibuprofen as compared to uncoated ibuprofen. This can be beneficial for applications such as taste-masking for immediate-release product where a change in dissolution profile is not desirable. This is shown in FIG. 5 below.

### Example 3

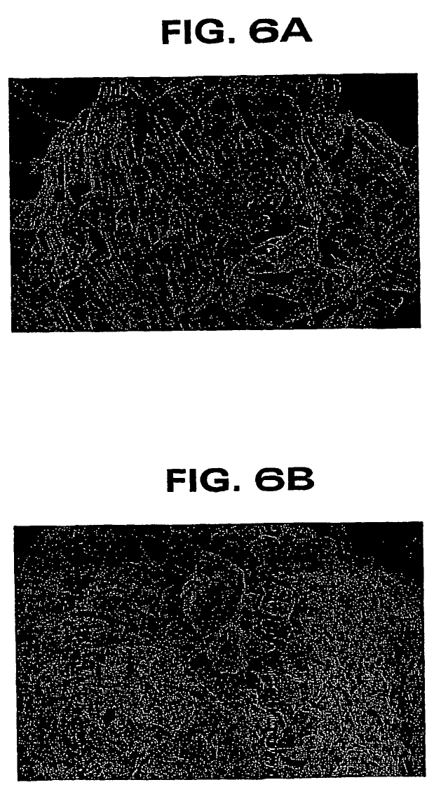

Caffeine, USP (Spectrum Chemical Co., Gardena, Calif.) were coated using the apparatus as shown in FIG. 1 and described in Example 2. The apparatus has a single screw metering feeder (AccuRate (Whitewater, Wis.) for metering the solid particles. In this experiment, ibuprofen was fed at a rate of 300-400 g/min. A peristaltic pump (Masterflex model 5718-10) was fitted with either Masterflex LS/25 (4.8 mm I.D) or LS/16 (3.1 mm I.D) Tygon elastomer tubing for metering the liquid. Eudragit was dissolved in acetone to form a coating solution. In some cases, triethyl citrate (used as a plasticizer), was also dissolved in the solution. The coating solution at room temperature was metered in a range of 20-30 g/min to the center tube. Heated nitrogen gas was used to atomize the coating solution producing a negative pressure in the mixing zone to induce the addition of the caffeine, and to provide the heat for evaporating the solvent. The product of the mixing/evaporation was conveyed through the mixing chamber to a cyclone to enable collection of the product. The product was passed repeatedly through the apparatus using the same process conditions as mentioned in this example. The final product samples had a coating mass fraction of 13-14% w/w. FIG. 6 shows scanning electron micrographs of coated and uncoated particles. The particle size distribution of the uncoated and coated caffeine is shown in Table 3. D10, D50 and D90 represent particle sizes in micrometers based on cumulative volume distribution at 10%, 50% and 90% respectively. The results indicate that by coating with Eudragit® EPO fine particles of caffeine tend to agglomerate and cause particles to break down making the distribution of particles narrower.

A headspace GC analysis, to measure any residual acetone, indicated that there was no residual solvent present in the final product.

TABLE 3
Particle Size Distribution of Caffeine Particles

| | Particle Size in Microns | | |
|---|---|---|---|
| | D10 | D50 | D90 |
| Uncoated | 1.89 | 11.95 | 58.11 |
| Coated | 5.27 | 12.31 | 28.16 |

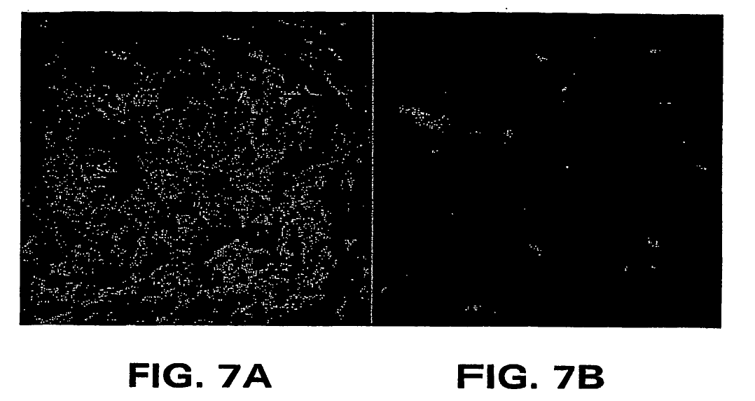

In addition, these particles were also analyzed using Time of Flight-Secondary Ion Mass spectroscopy (ToF-SIMS; PHI Model TRIFT II, Physical Electronics, Inc., Eden Prairie, Minn.). The particles were mounted on a double-sided sticky tape and introduced into the vacuum system of the instrument. Mass spectra were obtained using Indium primary source with a pulsed electron flood gun for charge compensation. The secondary ion mapping data was acquired by rastering the primary ion beam across the sample with pixel resolution of 256×256. The distribution maps as shown in FIG. 7 were generated by adding intensities of caffeine-specific or Eudragit® EPO—specific secondary ion peaks for each pixel. These maps indicate that most of the surface of caffeine particles is covered with Eudragit® EPO.

The dissolution profiles of coated and uncoated caffeine particles were generated in water using USP apparatus 2 at 50 rpm. For dissolution, the powders were directly-compressed into tablets after blending with fillers, disintegrant and lubricant as described above in Example 2.

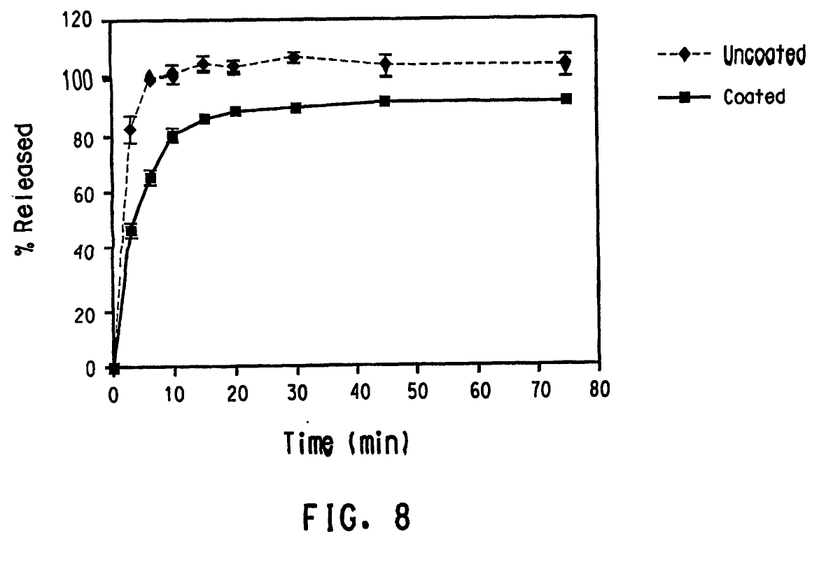

The dissolution results indicate somewhat slower dissolution rate during the initial sampling period, but almost all the drug came out within 20 minutes from both uncoated and coated particles. This again indicates that although the particles are coated, the type of polymer and the coating thickness are not sufficient to slow the dissolution significantly. These results are shown in FIG. 8.

### Example 4

This Example illustrates the second aspect of the process of the invention, wherein the particle to be coated is contained within the coating material prior to delivery to the coating process. As will be apparent to those skilled in this art, this aspect of the process is useful only in configurations wherein the particle to be coated is insoluble in the initial coating material.

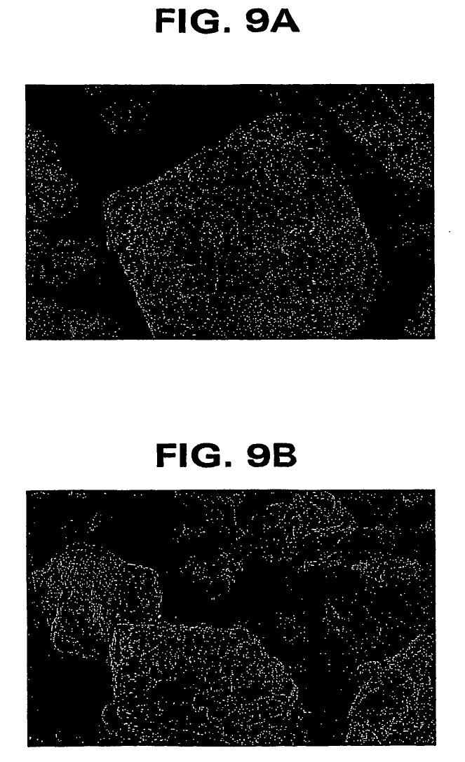

Sodium chloride powder, USP (Spectrum Chemical Co., Gardena, Calif.) were coated using the apparatus as shown in FIG. 1 and described in Example 2. A peristaltic pump was fit with Masterflex LS/25 (4.8 mm I.D) Tygon elastomer tubing for metering the liquid. Ethylcellulose was dissolved in acetone to form a coating solution. Triethyl citrate (used as a plasticizer), was also dissolved into the solution. Sodium chloride was dispersed in the coating solution. The dispersion at room temperature was metered in a range of 55-65 g/min to the nozzle. Heated nitrogen gas was used to atomize the dispersion and to provide the heat for evaporating acetone. Dry coated sodium Chloride was collected in the product container. FIG. 9 shows scanning electron micrographs of coated and uncoated particles.

The particle sizes of the uncoated and coated particles were measured using Beckman Coulter LS230 by dispersing the particles in isopropyl alcohol. The particle size distributions are shown in Table 4 do not indicate any change due to coating.

TABLE 4
Particle Size Distribution of Sodium Chloride Particles

| | Particle Size in Microns | | |
|---|---|---|---|
| | D16 | D50 | D84 |
| Uncoated | 6.501 | 21.79 | 35.87 |
| Coated | 3.649 | 15.7 | 31.55 |

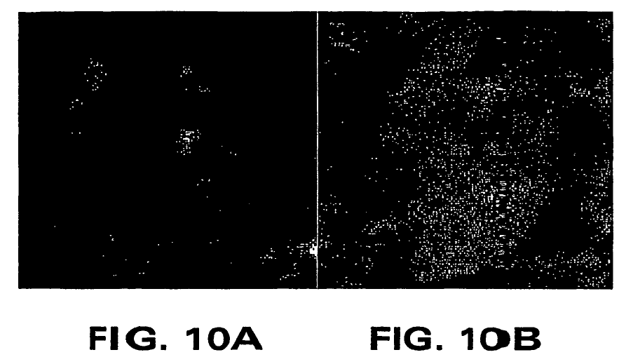

The ToF-SIMS secondary ion mapping also indicates that most of the surface of NaCI is covered with ethylcellulose (FIG. 10).

In addition, these particles were also analyzed using Time of Flight-Secondary Ion Mass Spectroscopy (Ion-ToF Model IV, Ion-ToF, Gm bH, Muenster, Germany). The particles were mounted on a double-sided sticky tape and introduced into the vacuum system of the instrument. Mass spectra were obtained using Gold primary source with a pulsed electron flood gun for charge compensation. The secondary ion mapping data was acquired by rastering the primary ion beam across the sample with pixel resolution of 128×128. The distribution maps as shown in FIG. 10 were generated by adding intensities of NaCl-specific or ethylcellulose-specific secondary ion peaks for each pixel. These maps indicate that most of the surface of NaCl particles is covered with ethylcellulose.

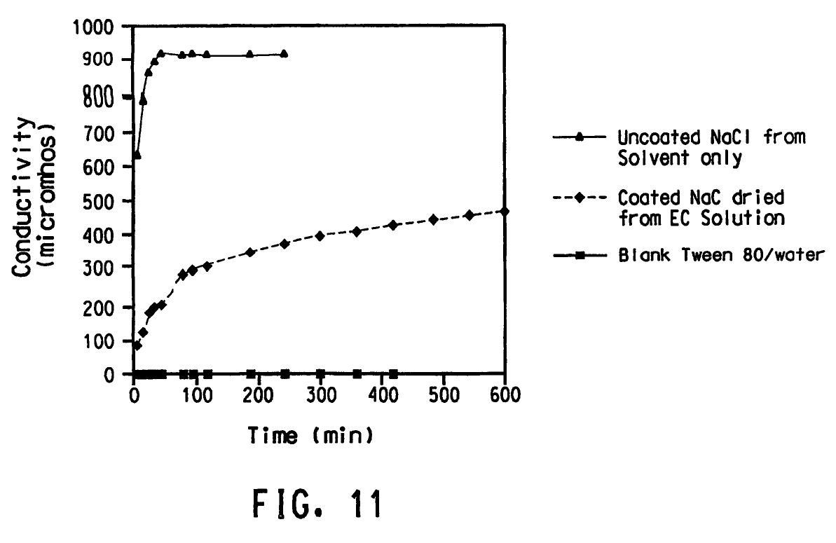

The dissolution behavior of NaCl in water was studied by measuring conductivity as a function of time while stirring at a constant rate using a magnetic stirrer. To ensure complete wetting, Tween 80 was used as a wetting agent. Uncoated NaCl exhibits an instantaneous conductivity profile. Coated NaCl, on the other hand, does not dissolve as quickly due to presence of ethyl cellulose coating and generates a much slower conductivity profile. This is shown in FIG. 11.

### Example 5

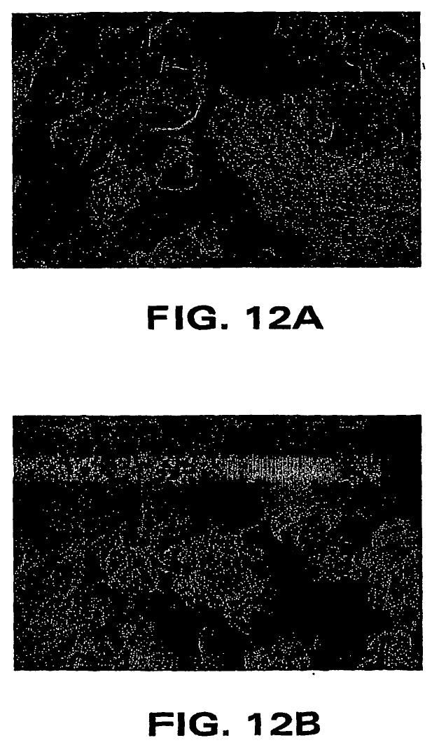

Ibuprofen particles were coated using the apparatus as shown in FIG. 1 and described in Example 2. The apparatus has a single screw metering feeder (Accu Rate) for metering the solid particles which were delivered at 325-425 g/min. A peristaltic pump was fit with Masterflex LS/1/6 (3.1 mm I.D) Tygon elastomer tubing for metering the liquid. Ibuprofen was metered to the system (g/min). Poloxamer®188 (Spectrum Chemical Co., Gardena, Calif.) was dissolved in acetone to form a coating solution. The coating solution at room temperature was metered in a range of 20-30 g/min to the nozzle. Heated nitrogen gas was used to atomize the coating solution, producing a negative pressure in the mixing zone to induce the addition of the Ibuprofen, and to provide the heat for evaporating any solvent from the ibuprofen. The product of the mixing/drying was conveyed down a 1.25″ (3.175 cm) I.D.×17″ (17.78 cm) long tube to a cyclone to enable collection oft he product. The product was passed repeatedly through the apparatus using the same process conditions as mentioned in this example. The final product samples had a Poloxamer mass fraction of 10-12% w/w. FIG. 12 shows scanning electron micrographs of coated and uncoated particles.

Particle size analysis done in an aqueous medium in Poloxamer is likely to dissolve. Therefore the results in Table 5 indicate size of primary particles which does not change after coating. This measurement may not be able to accurately determine size of agglomerates if any were forged during the coating process.

TABLE 5
Particle Size Distribution of Ibuprofen Particles

| | D16 | D50 | D84 |
|---|---|---|---|
| Uncoated | 1.431 | 5.691 | 12.37 |
| Coated | 1.312 | 4.916 | 13.61 |

The uncoated and coated powders were directly-compressed into a 200 mg strength tablet after blending with fillers, disintegrant, and lubricant, as described above in Example 2. The dissolution was performed in two dissolution mediums −0.1 N HCl and phosphate buffer (pH 7.2)—using USP apparatus 2 at 50 rpm. As controls for comparison, unprocessed ibuprofen, micronized ibuprofen and unprocessed ibuprofen blended with Poloxamer were also formulated as tablets for dissolution studies.

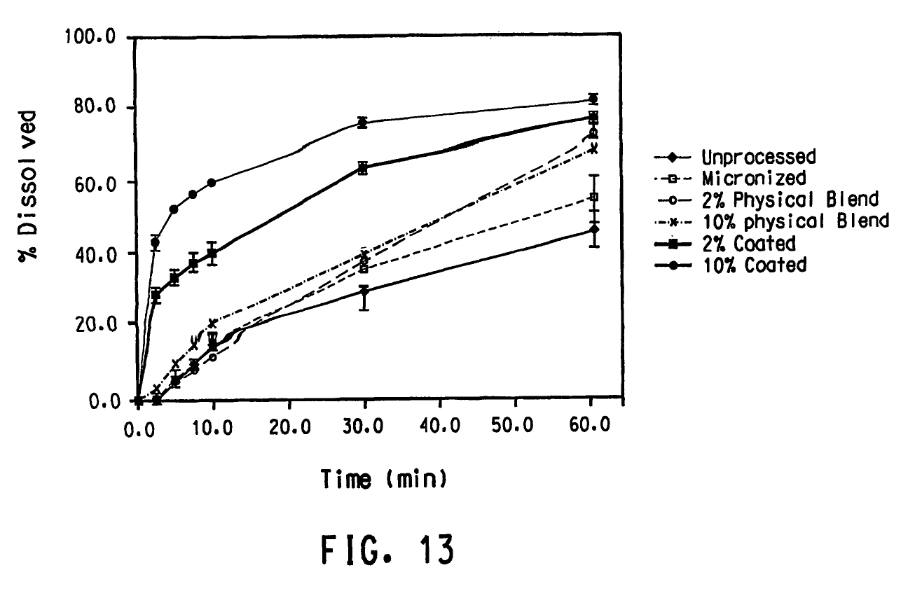

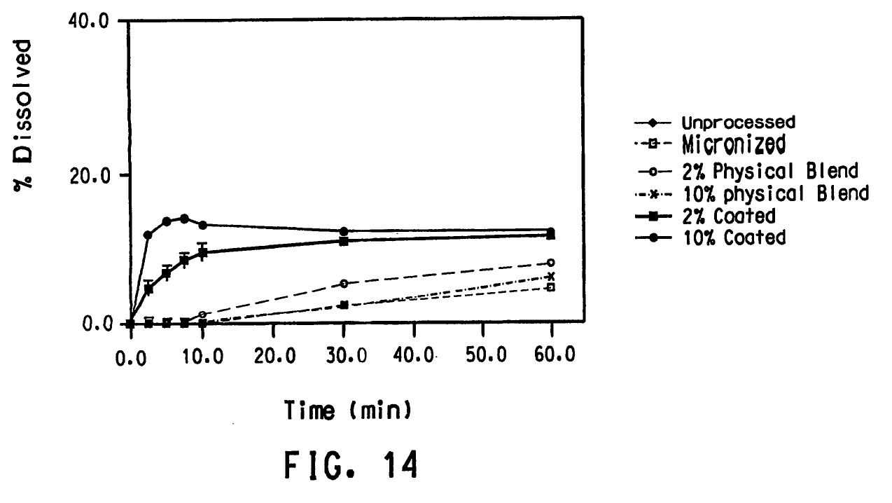

The results (FIGS. 13 and 14) show that at both pH's there is a significant increase in dissolution rate of ibuprofen by coating compared to physical blending with approximately the same amounts of Poloxamer.

The similar experiment was performed wherein ibuprofen particles were coated with SLS, and the coated particles exhibited a significantly increased rate of dissolution as compared with uncoated particles.

1. A process for coating a pharmaceutical particle with a liquid, the process comprising the steps of:
(a) metering a coating liquid into a flow restrictor;
(b) injecting a gas stream through the flow restrictor concurrently with step (a) to (i) atomize the coating liquid and (ii) create turbulent flow of the gas stream, wherein the gas stream is optionally heated; and
(c) adding a pharmaceutical particle to the turbulent flow region concurrently with steps (a) and (b) wherein the pharmaceutical particle mixes with the atomized coating liquid in the region of turbulent flow, to provide a coated pharmaceutical particle.

2. The process of claim 1, wherein the pharmaceutical particle is selected from the group consisting of vitamins, supplements, minerals, enzymes, proteins, peptides, antibodies, vaccines, probiotics, bronchodilators, anabolic steroids, antaleptics, analgesics, anesthetics, antacids, antihelmintics, anti-arrthymics, antibiotics, anticoagulants, anticolonergics, anticonvulsants, antidepressants, antidiabetics, antidiarrheals, anti-emetics, anti-epileptics, antihistamines, antihormones, antihypertensives, anti-inflammatories, antimuscarinics, antimycotics, antineoplastics, anti-obesity drugs, antiprotozoals, antipsychotics, antispasmotics, anti-thrombics, antithyroid drugs, antitussives, antivirals, anxiolytics, astringents, beta-adrenergic receptor blocking drugs, bile acids, bronchospasmolytic drugs, calcium channel blockers, cardiac glycosides, contraceptives, corticosteriods, diagnostics, digestives, diuretics, dopaminergics, electrolytes, emetics, haemostatic drugs, hormones, hormone replacement therapy drugs, hypnotics, hypoglycemic drugs, immuno suppressants, impotence drugs, laxatives, lipid regulators, muscle relaxants, pain relievers, parasympathicolytics, parasympathicomimetics, prostagladins, psychostimulants, sedatives, sex steroids, spasmolytics, sulfonamides, sympathicolytics, sympathicomimetics, sympathomimetics, thyreomimetics, thyreostatic drugs, vasodialators, and xanthines or combinations thereof.

3. The process of claim 1, wherein the liquid coating material comprises a starch, gelatin, a natural color, a synthetic color, a sugar, a cellulose, a biodegradable polymer, a biodegradable oligomer, an emulsifying wax, a fat, a wax, a phospholipid, a shellac, a flavoring agent, a moisture barrier, a taste-masking agent, an odor-masking agent, a shelf-life extending agent, a lipid, a protein, a mineral, cellulose derivatives, alginate, chitosan, surfactants and other wetting agents, carbohydrates, natural or synthetic polymers, methacrylate polymers and copolymers, polylactic acid (PLA) and polylactide co-glyceride (PLGA), ethyl cellulose, methyl cellulose, hydroxypropylcellulose, polyvinylpyrol idone, Aquateric™ Eudragit™, including any commercial grade or formulations thereof, acrylic coatings, Surelease™, bubble gum flavor, cherry flavor, grape flavor, sodium lauryl sulfate, sodium docusate, polysorbate, polyoxyethylene alkyl ethers, Cremophor, polyoxyethylene stearates, sorbitan fatty acid ester, Tween, poly lactic acid, polylactide glycolic acid, cellulose acetate pthalate, lactose, fructose, trehalose, microcrystalline cellulose, mannitol, dicalcium phosphate, , dextrates, croscarmellose sodium, sodium starch glycolate, povidone, silicon dioxide, stearic acid, a hydrocolloid, a monosaccharide, a disaccharide, an oligosaccharide, a polysaccharide, a surface modifying agent, a sugar alcohol, a poly-ol, a flow aid, an interparticle force control agent, magnesium stearate, talc, a pharmaceutically—active liquid, and combinations thereof.

4. The process of claim 1, further comprising repeating steps (a)-(c) at least once wherein the liquid coating material is the same or different.

5. A coated pharmaceutical particle made by the process of claim 1.

6. A process for coating a pharmaceutical particle with a liquid, the process comprising the steps of:
(a) metering a coating liquid containing pharmaceutical particles into a flow restrictor,
(b) injecting a gas stream through the flow restrictor concurrently with step (a) to (i) atomize the coating liquid and (ii) create turbulent flow of the gas stream and the atomized coating liquid, wherein the gas stream is optionally heated;
wherein the pharmaceutical particle mixes with the atomized coating liquid in the region of turbulent flow, to provide a coated pharmaceutical particle.

7. The process of claim 6, wherein the pharmaceutical particle is selected from the group consisting of vitamins, supplements, minerals, enzymes, proteins, peptides, antibodies, vaccines, probiotics, bronchodilators, anabolic steroids, analeptics, analgesics, anesthetics, antacids, antihelmintics, anti-arrthymics, antibiotics, anticoagulants, anticolonergics, anticonvulsants, antidepressants, antidiabetics, antidiarrheals, anti-emetics, anti-epileptics, antihistamines, antihormones, antihypertensives, anti-inflammatories, antimuscarinics, antimycotics, antineoplastics, anti-obesity drugs, antiprotozoals, antipsychotics, antispasmotics, anti-thrombics, antithyroid drugs, antitussives, antivirals, anxiolytics, astringents, beta-adrenergic receptor blocking drugs, bile acids, bronchospasmolytic drugs, calcium channel blockers, cardiac glycosides, contraceptives, corticosteriods, diagnostics, digestives, diuretics, dopaminergics, electrolytes, emetics, haemostatic drugs, hormones, hormone replacement therapy drugs, hypnotics, hypoglycemic drugs, immunosuppressants, impotence drugs, laxatives, lipid regulators, muscle relaxants, pain relievers, parasympathicolytics, parasympathicomimetics, prostagladins, psychostimulants, sedatives, sex steroids, spasmolytics, sulfonamides, sympathicolytics, sympathicomimetics, syrmpathomimetics, thyreomimetics, thyreostatic drugs, vasodialators, and xanthines or combinations thereof.

8. The process of claim 6, wherein the liquid coating material comprises a starch, gelatin, a natural color, a synthetic color, a sugar, a cellulose, a biodegradable polymer, a biodegradable oligomer, an emulsifying wax, a shellac, a flavoring agent, a moisture barrier, a taste-masking agent, an odor-masking agent, a shelf-life extending agent, a lipid, a protein, a mineral, cellulose derivatives, alginate, chitosan, surfactants and other wetting agents, carbohydrates, natural or syntheic polymers, methacrylate polymers and copolymers, polylactic acid (PLA) and poly lactide co-glyceride (PLGA), methyl cellulose, hydroxypropylcellulose, polyvinylpyrolidone, Aquateric™ (commercial coating), Eudragit™, including any commercial grade or formulations thereof, acrylic coatings, Surelease™, bubble gum flavor, cherry flavor, grape flavor, sodium lauryl sulfate, sodium docusate, polysorbate, polyoxyethylene alkyl ethers, Cremophor, polyoxyethylene stearates, sorbitan fatty acid ester, tween, poly lactic acid, poly lactide glycolic acid, cellulose acetate pthalate, lactose, microcrystalline cellulose, mannitol, dicalcium phosphate, dextrates, croscarmellose sodium, sodium starch glycolate, povidone, silicon dioxide, stearic acid, a hydrocolloid, a monosaccharide, a disaccharide, an oligosaccharide, a polysaccharide, a surface modifying agent, a sugar alcohol, a poly-ol, a flow aid, a n interparticle force control agent, magnesium stearate, a pharmaceutically-active liquid, talc, and combinations thereof.

9. The process of claim 6, further comprising repeating steps (a)-(b) at least once wherein the liquid coating material is the same or different.

10. A coated pharmaceutical particle made by the process of claim 6.

11. A coated pharmaceutical particle made by the process of claim 1 or 6 comprising ibuprofen coated with Eudragit® RL30D.

12. A coated pharmaceutical particle made by the process of claim 1 or 6 comprising ibuprofen coated with ethylcellulose.

13. A pharmaceutical particle made by the process of claim 1 or 6 wherein the coating the liquid is Poloxamer® 188.

14. A pharmaceutical particle of Claim 13, wherein the particle comprises ibuprofen.

15. A process for coating a carrier particle with a liquid comprising a pharmaceutically active ingredient, the process comprising the steps of:
(a) metering a coating liquid comprising a pharmaceutically active ingredient into a flow restrictor;
(b) injecting a gas stream through the flow restrictor concurrently with step (a) to (i) atomize the coating liquid and (ii) create turbulent flow of the gas stream, wherein the gas stream is optionally heated; and
(c) adding a carrier particle to the turbulent flow region concurrently with steps (a) and (b) wherein the carrier particle mixes with the atomized coating liquid in the region of turbulent flow, to provide a particle coated with a pharmaceutically active ingredient.

16. A process for coating a carrier particle with a liquid comprising a pharmaceutically active ingredient, the process comprising the steps of:
(a) metering into a flow restrictor a coating liquid comprising a pharmaceutically active ingredient wherein said liquid further comprises carrier particles;
(b) injecting a gas stream through the flow restrictor concurrently with step (a) to (i) atomize the coating liquid and (ii) create turbulent flow of the gas stream, wherein the gas stream is optionally heated;
wherein the carrier particles mix with the atomized coating liquid in the region of turbulent flow, to provide a particle coated with a pharmaceutically active ingredient.

17. The process of claims 15 or 16 wherein said carrier particles are comprised of inert material.

18. The process of claim 17, wherein said carrier particles are selected from the group consisting of silica, titanium dioxide and lactose.

19. Coated particles made by the process of claims 15 or 16.

20. The process of claims 15 or 16, wherein the pharmaceutically active ingredient in the liquid comprising a pharmaceutically active ingredient is selected from the group consisting of vitamins, supplements, minerals, enzymes, proteins, peptides, antibodies, vaccines, probiotics, bronchodilators, anabolic steroids, analeptics, analgesics, anesthetics, antacids, antihelmintics, anti-arrthymics, antibiotics, anticoagulants, anticolonergics, anticonvulsants, antidepressants, antidiabetics, antidiarrheals, anti-emetics, anti-epileptics, antihistamines, antihormones, antihypertensives, anti-inflammatories, antimuscarinics, antimycotics, antineoplastics, anti-obesity drugs, antiprotozoals, antipsychotics, antispasmotics, anti-thrombics, antithyroid drugs, antitussives, antivirals, anxiolytics, astringents, beta-adrenergic receptor blocking drugs, bile acids, bronchospasmolytic drugs, calcium channel blockers, cardiac glycosides, contraceptives, corticosteriods, diagnostics, digestives, diuretics, dopaminergics, electrolytes, emetics, haemostatic drugs, hormones, hormone replacement therapy drugs, hypnotics, hypoglycemic drugs, immunosuppressants, impotence drugs, laxatives, lipid regulators, muscle relaxants, pain relievers, parasympathicolytics, parasympathicomimetics, prostagladins, psychostimulants, sedatives, sex steroids, spasmolytics, sulfonamides, sympathicolytics, sympathicomimetics, sympathomimetics, thyreomimetics, thyreostatic drugs, vasodialators,, and xanthines or combinations thereof.

21. A composition comprised of pharmaceutical particles having a size greater than about 100 nm and less than about 100 um, coated with a surface active agent, wherein said particles exhibit enhanced dissolution.

22. The composition. of claim 21 wherein said the particles are coated with said surface active agent from between 0.1% to about 30% by % weight of the coating material to final weight of the composition of coated particles.

23. The composition of claim 22, wherein said particles exhibit an enhancement in rate of dissolution of at least 10%.

24. The composition of claim 23 wherein the particles are about 0.5 um to about 25 um, and are coated with surface active agent from between about 1% to about 20%.

25. The composition of claim 24, wherein the particles are about 1 um to about 15 um, and are coated with surface active agent from between about 1% to about 10%.

26. The particles of claim 25, wherein said particles exhibit an enhancement in rate of dissolution of at least 200%.

27. A particle of ibuprofen between 100 nm and 100 um coated with a surface active agent wherein said particle exhibits an enhanced rate of dissolution.

28. The particle of claim 27, wherein said surface active agent is Poloxamer® or SLS.

29. A particle of ibuprofen between 100 nm and 100 um coated with Poloxamer® wherein said particle exhibits an enhanced rate of dissolution.
